(19) United States
(12) Patent Application Publication
(10) Pub. No.: US 2004/0231482 A1
(43) Pub. Date: Nov. 25, 2004

(54) Food processing device

(76) Inventor: Howard Boilen, New York, NY (US)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/667,579

(22) Filed: Sep. 22, 2003

Related U.S. Application Data
(60) Provisional application No. 60/467,504, filed on May 2, 2003.

(51) Int. Cl. B26D 7/06; B26D 1/02

(52) U.S. Cl. 83/425.3; 83/932

(57) ABSTRACT

A food processing device includes various slicing, cutting and grating attachments for manually processing a food slidable thereover. The food processing device has a working surface and a pair of sidewalls, each sidewall containing a plurality of vertically oriented recesses in an bottom edge thereof. The recesses are positioned to engage a food utensils, such as a bowl, so that the processed foods are deposited in the bowl. A holder for the foods has a movable wall to apply even pressure to the food during processing.

### TECHNICAL FIELD

This invention relates to food processors generally and more particularly to a manually operated food processor that slices or grates foods and which can be integrated with various cooking utensils.

### BACKGROUND

Various food processors that slice or grate foods are known in the art. For example, in U.S. Pat. No. 4,038,892, a food slicer has an indexing turret that has various blades to provide different sized and shaped cuts in a foodstuff. The food slicer has a table lock that engages an edge of a table or counter to prevent movement during use. Such an arrangement results in deposit of the cut foodstuffs on the table surface.

In U.S. Pat. No. 4,212,431 a food processing unit has similar cutting and slicing arrangements, mounted on a rectangular base which forms a receiving chamber for the cut foodstuffs. The food processing unit also relies on a downward extension to form a detent edge holder that engages a table edge to hold the device during slicing.

In U.S. Pat. No. 5,745,999, a similar slicer, having an integral food receptacle is shown.

While various food slicing and grating devices are known, these typically either deposit foodstuff on a table top, or counter, or require integral receptacles that make the device large and cumbersome.

### SUMMARY OF THE INVENTION

It is an object of the present invention to provide a food slicer that can be easily associated with various cooking utensils such as pots, pans or bowls, for direct deposit of the processed food into the utensils.

It is another object of the present invention to provide a holder having a spring biased for receptacle with a spring biased movable wall for receiving and applying pressure to foodstuffs during slicing.

These and other objects of the present invention are achieved by a food processing device comprising a flat working surface having means for cutting and slicing a foodstuff integrated therewith; means for adjusting the cutting and slicing means; the working surface having a pair of opposed downwardly extending side walls, each side wall having a plurality of vertical recesses located in a facing relationship, the recesses positioned to fit over and engage a rim of a cooking utensil, such that processed foodstuff is received in the utensil.

Using the present invention, the food processor can be placed over, for example, a bowl, a lip of the bowl received in the recesses so as to lock the food processor and bowl together. The food processor can then be used to cut and/or slice the food product into pieces which are deposited directly into the bowl.

In another embodiment of the invention, a food holder is provided to safely hold large, or odd shaped foods, and to apply even pressure to the food during processing.

The holder comprises a handle, and a body portion having a width corresponding to the width of the food processor, the body portion having forward and rearward arched openings, a plurality of fixed prongs for engaging a foodstuff extending downwardly from the body portion, a reciprocally movable wall received by and riding along the prongs, the movable wall being biased in a downward direction and having a vertically extending plunger integral therewith, the plunger extending upwards through the handle when the movable wall is in an upper position.

In operation, the holder is positioned over the foodstuff, and moved downward so that the foodstuff is pierced by the prongs. This forces the movable wall to travel upwardly, extending the plunger through the handle. A user when pressing on the handle during the slicing operation, applies pressure to the plunger to press the foodstuff down to assure positive engagement with the processing blades. Such a holder improves performance and allows relatively large and/or odd shaped foods to be cut, sliced or grated effectively.

### BRIEF DESCRIPTION OF THE DRAWINGS

FIG. 1 is a perspective view of the food processor of the present invention.

FIG. 2 is a side view thereof.

FIG. 3 is a bottom view thereof.

FIGS. 4a, 4b and 4c show a side cross-sectional view of various cutting and slicing adjustments.

FIGS. 5a and 5b show the food processor received on a bowl.

FIGS. 6a, 6b and 6c show the optional extendible leg for height adjustable table mounting.

FIGS. 7a, 7b and 7c show the food processor with optional grating inserts, and auxiliary blade inserts.

### DETAILED DESCRIPTION OF THE INVENTION

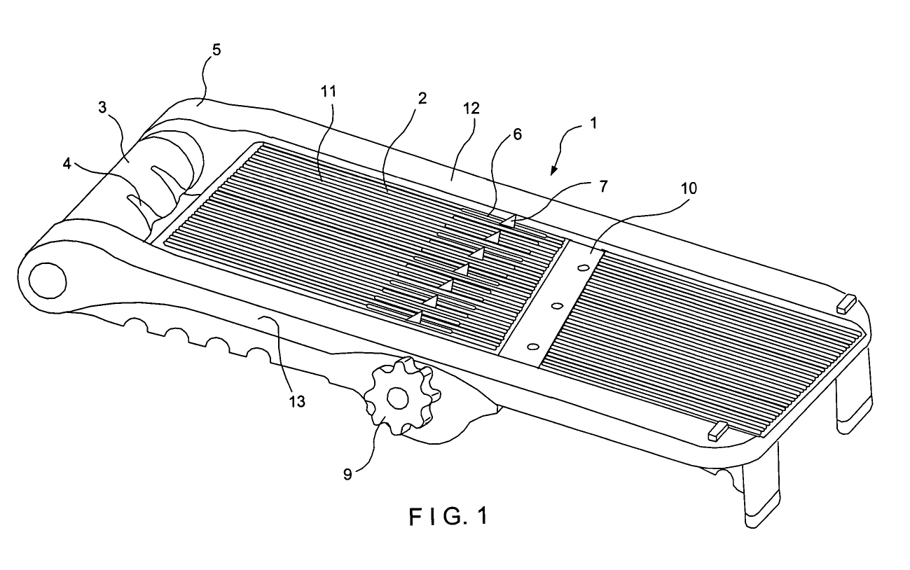

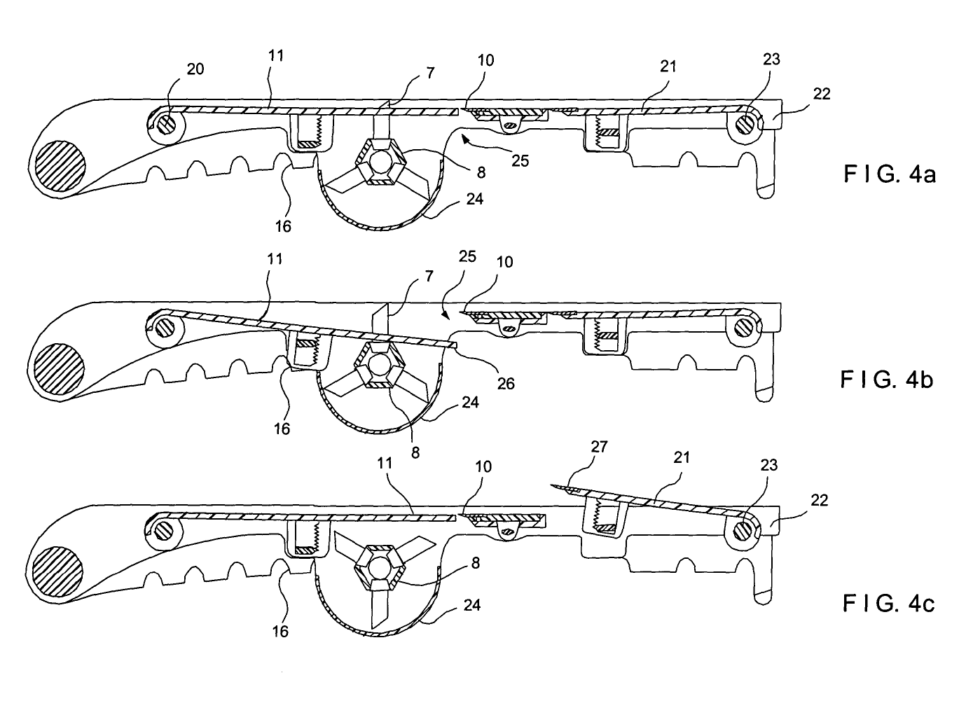

Referring to FIG. 1, a food processor 1 has a work platform 2 over which a foodstuff, such as a potato, may pass for slicing. The food processor has a handle 3 with finger grips 4 at a first end 5 thereof. The work platform has a plurality of slots 6 through which selectable blades 7 extend upwardly. Various blade configurations and spacings may be used, projecting from a rotatable cylinder 8 (see FIG. 4a) having a turning knob 9. Rotating the knob selects the type or numbers of blades to be projected. A removable horizontal blade 10 is used to slice the foodstuff horizontally while the blades 7 slice vertically. In this way, various shapes and sized of cuts may be made. The removable blade may have a flat or wavy profile, or be replaced by a blank insert.

An upper portion 11 of the work platform 2 is vertically displaceable so as to adjust the depth of the vertical slice, these being adjustable by the user.

The work platform 2 has a pair of fixed side rails 12 and 13 upon which a holder travels, as will be described further below. The side rails rise above the work platform to a height generally corresponding to height of the vertical blade located on the cylinder 8.

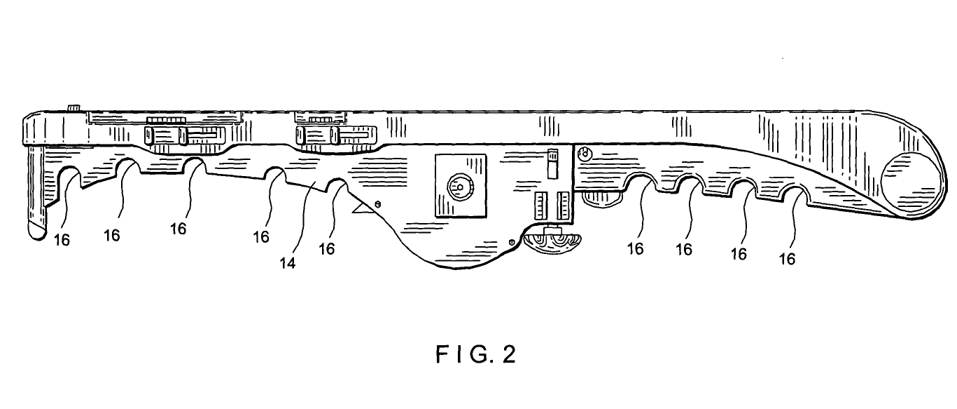

Referring to FIG. 2, a side view of the food processor is shown. The food processor has a pair of opposed identical sidewalls 14 and 15, each sidewall having a plurality of vertically oriented recesses 16 in the bottom edge thereof. The recesses are arranged in a facing relationship so that a bowl, pan or other cooking utensil may be placed securely the food processor, a lip of the utensil received in the recesses corresponding to the diameter of the utensil. Most utensils such as pots, pans and bowls have fairly standard dimensions which are taken into consideration in determining the location of the recesses to provide the broadest possible utilization of the food processor.

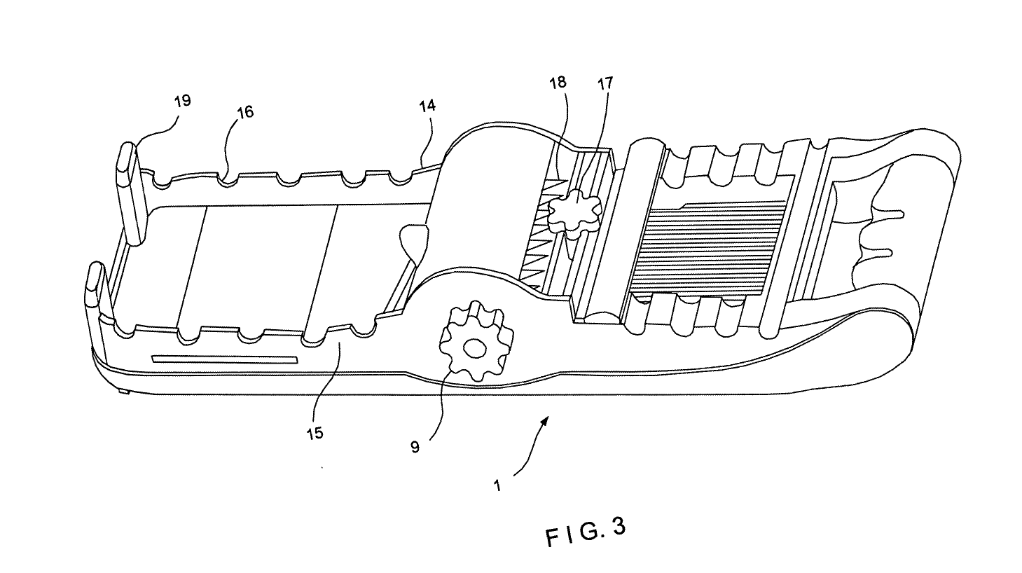

Referring to FIG. 3, a bottom view of the food slicer is shown. An adjusting knob 17 is used to displace the moveable upper portion 11 of the work platform. A series of blades 18 is also shown in an idle position, that is, when that particular set of blades is not selected for use. For ease of storage, a pair of feet 19 allows the food slicer to remain level, when placed on a flat surface, or to hang on a wall when not in use, for ease in storage.

FIG. 4a shows the food processor 1 with the movable upper work portion 11 in its full upright position. In this orientation, the blades 7 extend upwardly through the slots 6 a minimum amount. The movable upper work portion 11 is attached by a hinge 20 to the food processor 1 and is downwardly displaceable. The food processor also has a lower upwardly movable work portion 21, attached at a second end 22 of the food processor 1 by a hinge 23. In FIG. 3a, this is located in its most downward or idle position. The rotatable cylinder 8 is also shown having six positions, three different blade configurations, and three neutral positions if vertical slicing is not needed. The blades not in use are enclosed within a hinged protective cap 24. The protective cap may be opened to allow cleaning of the blades after use. An opening 25 provides space to allow the downward displacement of the wall 11.

FIG. 4b shows the movable wall 11 in its maximum downward orientation. This gives the thickest slice, i.e. the space between wall end 26 and the blade 10, the spacing between the blades 7 determining the width of the slices made.

FIG. 4c shows the cylinder 8 in its idle position, the movable wall in its flush or idle position, and the lower movable work portion 21 in a full upright position. The lower movable work portion has a removable auxiliary blade 27 which provides solely a horizontally cut to the foodstuff. The auxiliary blade may have a flat or wavy profile.

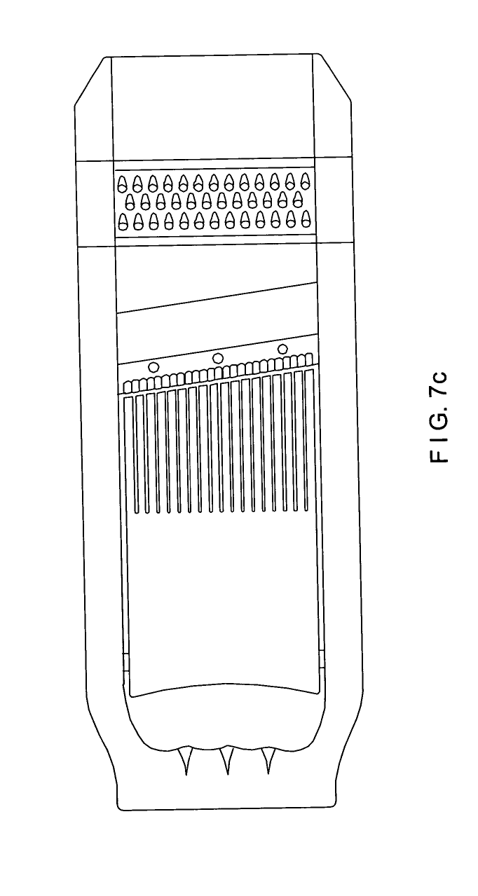

The auxiliary blade 27 can also be replaced by a grating insert to grate various food products as shown in FIGS. 7a, 7b and 7c, as will be discussed below. The openings and profiles of the grating may vary with particular inserts sized to be quickly swapped in to the food processor.

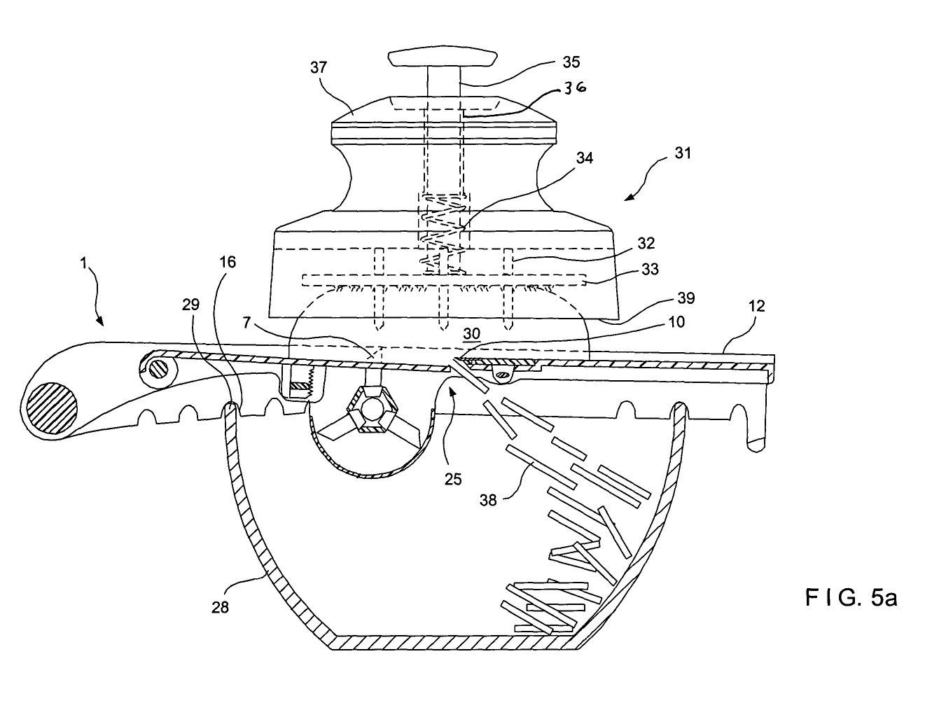

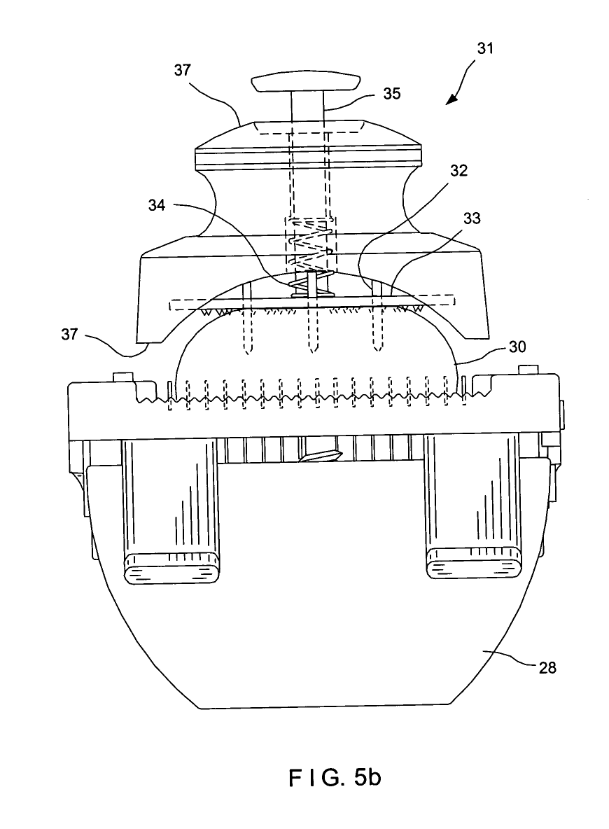

Referring to FIG. 5a, the food processor, 1 is placed on a bowl 28 having a rim 29 received in recesses 16. A foodstuff, for example a potato 30 is engaged to a holder 31 by prongs 32. The holder has a movable wall 33 biased by a spring 34 into downward engagement with the potato 30. A plunger 35 extends through a center passage 36 in the holder, through a handle 37. This enables a user to apply downward pressure to the potato to assure positive engagement with the vertical blades 7 and the horizontal blade 10. Sliced portions 38 travel through the opening and are received in the bowl 28. The holder has a pair of side edges 39 which, when the potato is nearly gone, engage the side rails 12 and 13, as best seen in FIG. 5b. This enables slicing to continue until the wall 33 is in its most downwardly extended position, the side rails preventing the holder or prongs from engaging the cutting and slicing blades.

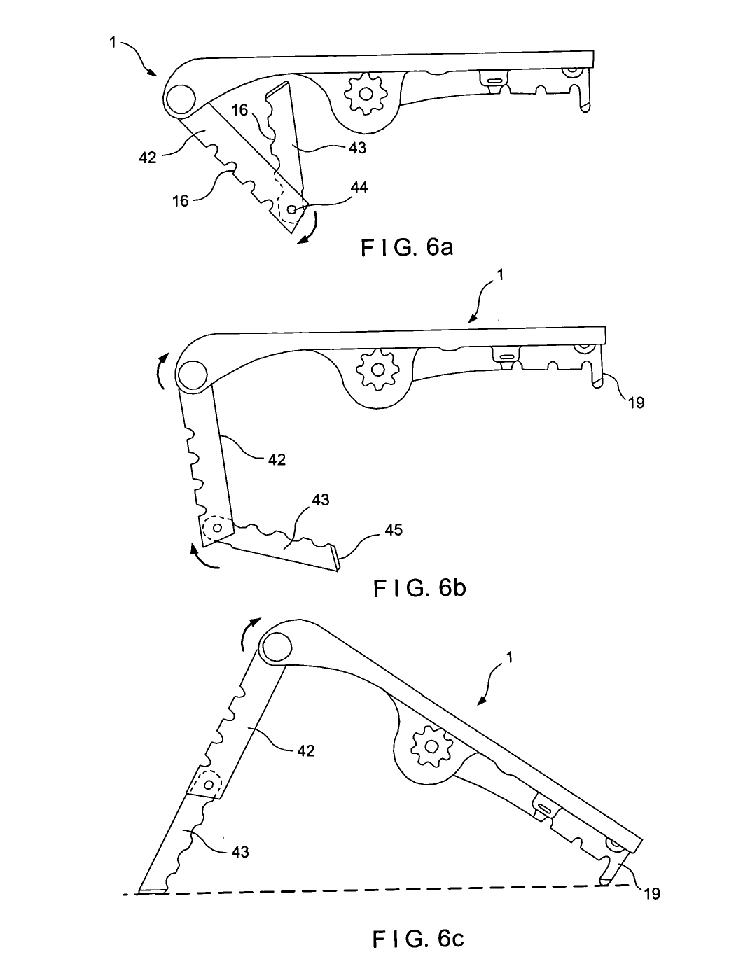

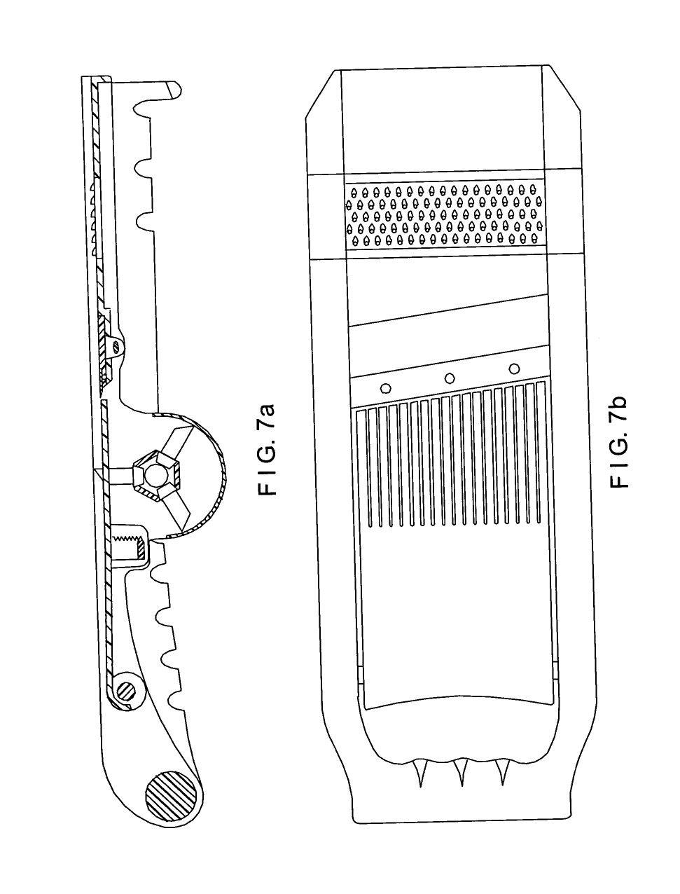

Referring to FIG. 6a, a portion of the sidewalls 40, containing a number of the recesses 16 is supported by a hinge 41 in the handle 3. The side wall portion is thus foldable and can be extended to provide a pitched work surface for processing foodstuffs if that is the user's preference.

In FIG. 6a, the sidewall portion has an upper leg 42 and a lower leg 43 attached at a hinge 44 to the upper leg. The upper leg and lower legs have alignable recesses 16 when in the fully folded storage position. FIG. 6b shows the legs partially extended, and it should be noted that the upper leg alone can provide a stand for the food processor at an intermediate height. The lower legs 43 have non-slip feet 45, as do the legs 19, to minimize movement when used in this orientation.

Thus, the food slicer can be used on a utensil, or be used with the two height adustable folding legs that form part of the sidewall structure, each leg having the appropriate recesses for accepting a utensil when in the folded position, forming the side walls for the work platform.

Referring to FIGS. 7a, 7b and 7c, these show different blade/food grater arrangements that may be incorporated with the food slicer of the invention, each having different sized openings and cutting profiles.

While preferred embodiments of the present invention have been shown and described, it will be understood by those skilled in the art that various changes could be made without varying from the scope of the present invention.

What is claimed is:

1. A food processing device comprising a flat working surface having means for processing a foodstuff integrated therewith; means for adjusting the processing means; the working surface having a pair of opposed downwardly extending side walls, each side wall having a plurality of vertical recesses located in a facing relationship, the recesses positioned to fit over and engage a rim of a cooking utensil such that processed foodstuff is received in the utensil.

2. The food processing device of claim 2 wherein the processing means comprising at least one slicing blade.

3. The food processing device of claim 1 wherein the processing means comprise a plurality of slicing blades.

4. The food processing device of claim 1 wherein the processing means comprise a plurality of vertical blades and at least one horizontal blade.

5. The food processing device of claim 1 wherein each sidewall comprises an upper leg hinged at one end to a first end of the working surface, a lower leg hinged to a second end of the upper leg, the lower leg foldable onto the upper leg and the upper leg foldable beneath a side edge of the working surface.

6. The food processing device of claim 1 wherein the processing means comprises at least one food grating surface.

7. The food processing device of claim 1 further comprising a removable auxiliary blade for horizontally slicing the foodstuff.

8. The food processing device of claim 1 wherein from 2 to 20 vertical recesses are disposed along each side wall.

9. The food processing device of claim 4 wherein the horizontal letting blade is removable, the blade being flat.

10. The food processing device of claim 4 wherein the horizontal cutting blade is removable and the blade is wavy.

11. Th food processing device of claim 1 further comprising a pair of longitudinal parallel guide ribs located on opposite side of the working surface, the guide ribs being higher than the working surface, at a height corresponding to at least the height of the means for processing the foodstuff.

12. The food processing device claim 7 wherein the auxiliary blade is flat.

13. The food processing device of claim 7 wherein the auxiliary blade is wavy.

14. A holder for foodstuffs for use with a food processing device comprising a body portion having forward and rearward arched openings, a plurality of fixed prongs extending downwardly from the body portion, a reciprocally movable wall disposed within the body portion and received by and sliding along the prongs, biasing means for biasing the movable wall in a downward direction, the movable wall having a vertically extending plunger integral therewith, the plunger extending upwards through a handle located on a top surface of the body portion when the movable wall is in an upper position.

15. The holder of claim 14 wherein the handle is a pillar extending upwardly from the body portion.

16. The holder of claim 14 wherein the biasing means is a spring.
